(19) United States
(12) Patent Application Publication
(10) Pub. No.: US 2006/0166617 A1
(43) Pub. Date: Jul. 27, 2006

(54) Broadcast data processing

(75) Inventor: Steve Passmore, Surrey (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/637,872

(22) Filed: Aug. 8, 2003

Related U.S. Application Data
(60) Provisional application No. 60/403,918, filed on Aug. 15, 2002.

(30) Foreign Application Priority Data
Aug. 9, 2002 (GB) 0218440.6

(51) Int. Cl. H04H 7/00

(52) U.S. Cl. 455/3.06; 455/414.3

(57) ABSTRACT

A method and computer programs for a radio device and a server in a system in which a radio device receives (410) radio a broadcast item of entertainment content and associated information identifying it, plays it (420) and detects (450) if it is preferred by a user, and if yes, sends (470) to a mobile telecommunications network an associated information signal containing the associated information for further processing in an external server. The server uses the associated information to provide a value-added service, for example to retrieve related content, to forward a pointer to the preferred item of entertainment content or to retrieve background information relating to the preferred item of entertainment content.

### FIELD OF THE INVENTION

This invention relates to the provision of value-added services related to radio broadcast data. It also relates particularly, but not exclusively, to using associated information such as RDS text for an item of entertainment content (e.g. song) in a radio broadcast to request and/or provide value-added services to a mobile radio device.

### BACKGROUND OF THE INVENTION

Radio Data Service (RDS) and its American equivalent Radio Broadcast Data Service (RBDS) allow amongst other things, automatic tuning to radio stations from which strongest signals are received, showing radio station names, automatic searching programs of particular type such as news or classic music and providing traffic announcements. RDS is thus well suited for car radios. In the near future, RDS will also be employed in radios integrated in portable telephones, Personal Digital Assistants (PDA) or generally mobile stations. This is beneficial as the mobile stations are often used in different places (as in the car radio case) where different sets of radio stations and frequencies are receivable. The RDS can greatly facilitate mobile radio use by automatically providing the names and frequencies of radio stations.

RDS also allows receiving textual information, such as a static Programme Service name (PS) that gives the name of the radio station and a dynamic Radio Text (RT) that may carry temporally changing text such as advertisements. Displaying dynamic texts may yet be found distracting in car use, but far less so in public transport where a user listens to the radio with headphones, for instance. As the number of portable RDS devices grows, it will become more common to broadcast temporally changing information using RDS, for example advertisements and information about a current program.

### SUMMARY OF THE INVENTION

According to a first aspect of the invention there is provided a method in a radio device comprising the steps of:

receiving a radio broadcast item of entertainment content and associated information for the item of entertainment content;

allowing a user to request a value-added service based on the associated information; and

responsive to the request, producing an associated information signal based on the associated information for providing the value-added service.

Advantageously, the method produces an associated information signal that allows value-added external processing of the associated information thus allowing various added value services with very little user effort. The method allows requesting value-added services without the need to memorise any codes, addresses or links so that it can be conveniently used, for example, when no paper and pen is available or writing would be difficult or non-advisable.

Advantageously, the method reverses the approach on the associated information so that it is not only locally presented to the user but can be used as a basis for value-added services. Consequentially, the received associated information can be used as a basis for external processing that can provide more added value than local processing could provide.

Preferably, the radio device is a mobile radio device. Alternatively, it is a fixed radio device.

Advantageously, the mobile radio device receives from a radio broadcast both the item of entertainment content and the associated information. The producing the associated information signal provides true freedom of mobility, for example, to use the method while commuting to and from work.

Preferably, the item of entertainment content comprises information for audible presentation. This allows presentation of the item of entertainment so that the user may decide on requesting value-added services without the need to watch at any display or indicator.

The item of entertainment content may comprise information for visual presentation. This allows providing visual information.

The item of entertainment content may comprise information for either or both audible and visible presentation. The latter embodiment allows providing a user with an enhanced experience including audible and visual presentation. A user may still decide on requesting value-added services solely based on either visual or audible observations.

Preferably, the item of entertainment content and associated information for the item of entertainment content are received concurrently.

Preferably, the item of entertainment content is received together with the associated information for the item of entertainment content.

The receiving of the item of entertainment content and associated information together and/or concurrently allows the radio device to present the associated information or variation thereof to its user during presenting the item of entertainment content.

Preferably, the item of entertainment content and associated information are presented concurrently. Preferably, they are presented in a distinguishing format or separately perceivable by a user for example by using audio-video, spacing them apart in time or on a display or in presenting them in different tone, voice, pitch or amplitude.

Preferably, the method comprises receiving the broadcast item of entertainment content from an FM radio broadcast.

Preferably the associated information comprises information conveyed by RDS data, a regional equivalent or information derived therefrom. Advantageously, the method makes use of the existing vast geographical coverage of RDS and RBDS (the American version of RDS) service.

Preferably, the associated information signal is sent over a mobile telecommunication network to a server for producing said value-added service. Advantageously, the radio device can request the value-added service over the mobile telecommunications network from substantially anywhere.

Alternatively, the associated information signal is sent to an external electronic device independent of telecommunications networks. Advantageously, the radio device can exchange information received as RDS text with another device over a fixed or wireless connection. The wireless connection may be a Low Power Radio Frequency connection (Wireless LAN or Bluetooth, for instance), infra-red connection or over an acoustic connection such as an ultrasound or wide-band acoustic connection.

Advantageously, the external device may then forward the associated information signal to an external service provider so that the cost of the service can be transferred from one subscription to another, or the service can be accessed with such a device that has a subscription that supports the value-added service.

Preferably, the external device is a mobile device. Alternatively, it is a fixed device, for example a personal computer or a game station.

Preferably, the method comprises buffering previous associated information or a variation thereof so that a user may select the associated information and/or a variation thereof related to a past item of entertainment content as the basis for forming the associated information signal. Advantageously, a user may subsequently decide to ask for value-added services regarding an item of entertainment content that has been previously received.

Preferably, the method comprises buffering part or samples of the past items of entertainment content and presenting them again so that a user can later decide if he or she wishes to obtain value-added services based on a particular item of entertainment content.

Preferably, the method comprises subsequently receiving from the telecommunications network value-added information related to the item of entertainment content and presenting all or at least part of the value-added information. Advantageously, a user can be provided with value-added information such as sound clips or trailers of corresponding songs or movies from the same artist, producer or from the same category of art, for instance.

Preferably, the item of entertainment content is a song, video, a movie, a news report concerning a particular item, an item in a broadcast contest program or the portion representing particular area or item of interest in a weather forecast, financial report or educational broadcast or portion thereof.

Preferably, the telecommunications network is a mobile telecommunications network. Advantageously, the use of a mobile telecommunications network allows using the first aspect while travelling thus providing value-added information for the hours of commuting.

Preferably, the associated information is received as broadcast side information along with items of entertainment content. Advantageously, the associated information may be modulated separately to the item of entertainment content as in RDS, or it may be contained in separate control and signalling information such as packet headers in case of packet based radio broadcast.

Even more preferably, the associated information characterises or identifies the item of entertainment content. Advantageously, the identity of the item allows providing value-added services.

Preferably, the value-added service is a service provided in an external device, such as a server. For example, the value-added service may be searching for related information such as discography, providing related item or items of entertainment content or forwarding the identity or any related information to a user device.

Alternatively, the value-added service is transmitting the associated information signal locally to an external device, which is preferably mobile or fixed. Advantageously, the user of the radio device may transmit the associated information to another radio device, for example, responsive to a user request.

Preferably, the method contains a step of providing a user of the radio device with the item of entertainment content. Advantageously, by presenting the item of entertainment content to which the associated information relates the user may easily and intuitively decide if a value-added service is desired for that item of entertainment.

Preferably, this providing the user with the item of entertainment content comprises audible presentation so that a user can decide whether to request a value-added service without visual observations. This is particularly useful in the mobile use in which the mobile radio device may be out of sight e.g. in a pocket.

According to a second aspect of the invention there is provided a method in a server accessible to a radio device, comprising the steps of:

receiving from a radio device an associated information signal based on radio broadcast associated information for a radio broadcast item of entertainment content;

preparing value-added information related to the item of entertainment content based on the associated information signal; and

outputting the value-added information.

Preferably, the outputting comprises a sub-step of sending the value-added information to the radio device or to a different radio device. Advantageously, the method allows a user of a radio device to conveniently obtain value-adding information related to a particular item of entertainment content or to provide some other radio device with information related to that particular item of entertainment content.

According to a third aspect of the invention there is provided a radio device comprising:

a radio receiver for receiving a radio broadcast item of entertainment content and associated information for the item of entertainment content;

a user interface for allowing a user to request a value-added service based on the associated information; and

a processor for producing an associated information signal based on the associated information for providing the value-added service responsive to the request.

Preferably, the radio device is selected from a group consisting of: a mobile station, a personal digital assistant device, a portable computer, an electronic game, a two-way pager, a two-way car communication unit, a home entertainment module system or module, and a radio enabled fixed computer such as a personal computer (PC).

Preferably, the receiver is adapted to receive broadcast items of entertainment content and associated information from an FM radio broadcast signal.

Preferably, the radio device comprises a memory for buffering previous associated information and the user interface being configured to allow a user to select the associated information related to a past item of entertainment content as the basis for forming the associated information signal to the telecommunications network.

Preferably, the radio device comprises a memory for buffering samples of the past items of entertainment content and the user interface being configured to present them again so that a user can later decide if a value-added service based on a particular item of entertainment content is desired.

Preferably, the radio device has been configured to include in the associated information signal sufficient information for determining the origin of the item of entertainment content.

Preferably, the radio device comprises a transmitter for transmitting to the server the associated information signal.

Preferably, the transmitter is a mobile telecommunications network compatible transmitter.

The radio device may also comprise a local communication block for locally exchanging the associated information signal with another device.

According to a fourth aspect of the invention there is provided a server accessible to a radio device, comprising:

an input for receiving from a radio device an associated information signal based on a radio broadcast item of entertainment content received by the radio device;

a processor for preparing value-added information based on the associated information signal; and

an output for outputting the value-added information.

Preferably, the radio device is the radio device of the third aspect.

According to a fifth aspect of the invention there is provided a system comprising a a server and a plurality of radio devices accessible to the server, wherein one or more of the radio devices comprise:

a radio receiver for receiving radio broadcast item of entertainment content and associated information for the item of entertainment content;

a user interface for allowing a user to request a value-added service based on the associated information;

a processor for producing an associated information signal based on the associated information for providing the value-added service responsive to the request; and

a transmitter for transmitting the associated information signal to the server; and wherein the server comprises:

an input for receiving the associated information signal from the radio device;

a processor for preparing value-added information based on the associated information signal; and

an output for outputting the value-added information.

Preferably, the system comprises a radio broadcast station for radio broadcasting items of entertainment content and associated information for them.

Preferably, the system comprises a first data storage containing program information using which together with the associated information signal the server can identify the item of entertainment content.

Preferably, the system contains a second data storage containing value-added information related to various items of entertainment content.

Preferably, the first and second storage are stored on the same memory medium. Alternatively, they are stored on different memory media. They may be stored in a distributed database such as in a number of memory media accessible via the Internet.

Preferably, the system comprises a mobile telecommunications network for relaying data between the radio device and the server.

According to a sixth aspect of the invention there is provided a computer program product for controlling a radio device, comprising:

computer executable program code for causing the radio device to receive radio broadcast item of entertainment content and associated information for the item of entertainment content;

computer executable program code for causing the radio device to allow a user to request a value-added service based on the associated information; and

computer executable program code for causing the radio device to produce, responsive to the request, an associated information signal based on the associated information for providing the value-added service.

According to a seventh aspect of the invention there is provided a computer program product for controlling server accessible to a radio device, comprising:

computer executable program code for causing the server to receive from the radio device an associated information signal based on a radio broadcast item of entertainment content received by the radio device;

computer executable program code for causing the server to prepare value-added information based on the associated information signal; and

computer executable program code for causing the server to output the value-added information.

According to an eighth aspect of the invention there is provided a memory media carrying the computer program product of the seventh or eighth aspect.

According to a ninth aspect of the invention there is provided a method generating revenue by charging for the provision, on request, of value-added information related to a radio broadcast item of entertainment content received by a radio device.

According to a tenth aspect of the invention there is provided a method of providing, on request, of value-added information related to a radio broadcast item of entertainment content received by a radio device.

The embodiments of any aspect are intended to be combined with other aspects even though not all embodiments are expressly written for all aspects in sake of brevity.

### BRIEF DESCRIPTION OF THE DRAWINGS

The invention will now be described, by way of example only, with reference to the accompanying drawings, in which:

FIG. 1 shows a diagram of main elements in a system according to a preferred embodiment of the invention;

FIG. 2 shows a diagram of main elements of a mobile radio device of FIG. 1;

FIG. 3 shows a diagram of main elements of a Value-added Service server of FIG. 1;

FIG. 4 shows a flow chart of the operation of the mobile radio device of FIG. 1; and

FIG. 5 shows a flow chart of the operation of the VAS server of FIG. 1;

### DETAILED DESCRIPTION

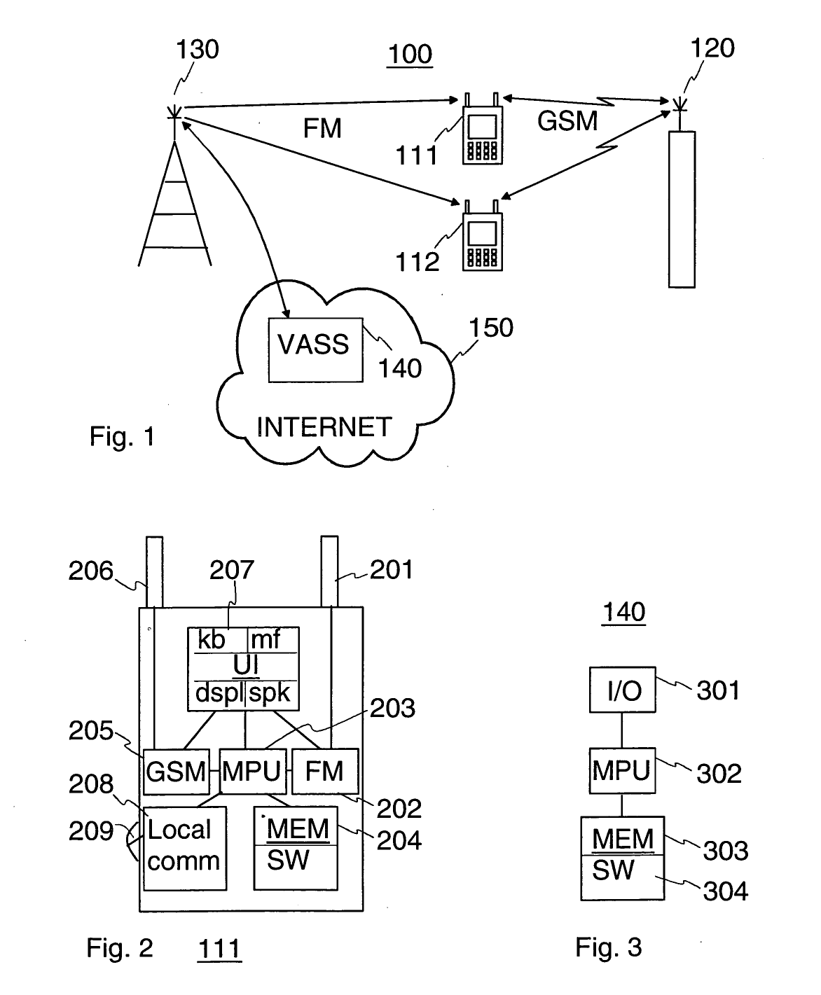

FIG. 1 shows a diagram of main elements in a system 100 according to a preferred embodiment of the invention. The system comprises a first mobile radio device 111, a second mobile radio device 112, an FM Radio Data Service (RDS) radio broadcast station 120, a serving GSM base station 130 that can provide mobile communications services to the mobile radio devices 111,112 in its coverage area, and a Value-added Service Server (VASS) 140 that is connected to the GSM base station 130. The mobile radio devices 111 and 112 are in this example similar. The VASS 140 typically resides in the Internet 150 and is connected to the GSM base station 130 through the Internet 150 and through the GSM network to which the GSM base station 130 belongs. The invention will be explained by reference to system 100 in which Frequency Modulated radio broadcast is received with RDS enabled mobile radio devices that additionally have GSM telecommunications functionality. The invention also applies to various types of broadcast stations including Digital Audio Broadcast (DAB) stations, telecommunications networks and mobile radio devices as will be understood by a person ordinarily skilled in the art.

FIG. 2 shows a diagram of main elements of the first and second mobile radio devices 111 and 112. The mobile radio device 111 comprises an FM antenna 201, typically built in, for receiving FM RDS transmissions containing both items of entertainment content (songs in a radio program, for example) and associated information (RDS data). The FM antenna 201 feeds signals to an FM module 202 that is capable of decoding the FM RDS transmissions. The FM module 202 is also connected to a Master Processing Unit (MPU) 203 that controls the operation of the mobile radio device 111 and to User Interface (UI) 207. The MPU 203 is connected to a memory 204 that contains software that determines the operation of the MPU 203. The MPU 203 is additionally connected to a GSM module 205 and to the UI 207. The GSM module 205 is capable of converting signals between a format suitable to the MPU and a format suitable to a GSM antenna 206, to which it is further connected. The GSM module is controlled by the MPU 203. The UI 207 comprises typical user interface blocks such as a keyboard, a display, a microphone and a speaker. It may contain a speech synthesiser or speech recognition unit, or they may be provided at least partly using the MPU 203 to facilitate user interfacing. Basically, the mobile radio device 111 is capable of receiving and presenting the items of entertainment content from the FM transmissions, to provide RDS services such as displaying RDS texts and to communicate with a mobile telecommunications network.

FIG. 2 shows additionally optional elements local communication block 208 connected to the MPU 203 and to a local communication port 209. These elements allow communicating directly with an external device that may be a mobile device, for example, similar to the mobile radio device 111 or a fixed device. The local communication block 208 is typically a Low-Power Radio Frequency (LPRF) unit capable of short-range (up to 10 to 300 m, for example) radio communications, such as a Bluetooth, Wireless LAN, or DECT unit. Alternatively, it may be an infrared, ultrasound, or fixed communications unit. The port 209 is correspondingly an antenna, an optical port or an acoustic port. These optional elements 208 and 209 are only needed in an embodiment of the invention, explained in the end of this detailed description.

FIG. 3 shows a diagram of main elements of the VASS 140. The VASS 140 comprises an Input/Output (I/O) block 301 for communicating with the Internet, connected to a Master Processing Unit (MPU) 302, which is also connected to a memory 303. The memory 303 contains software 304 that determines the operation of the VASS 140 and provides working memory for the MPU 302. The VASS 140 is configured so that it can be operated over the Internet through the I/O block 301 with password protection and thus it need not have a dedicated user interface. The VASS 140 is configured to provide secure communications with different mobile telecommunications networks using typical authentication and encryption protocols known from the art.

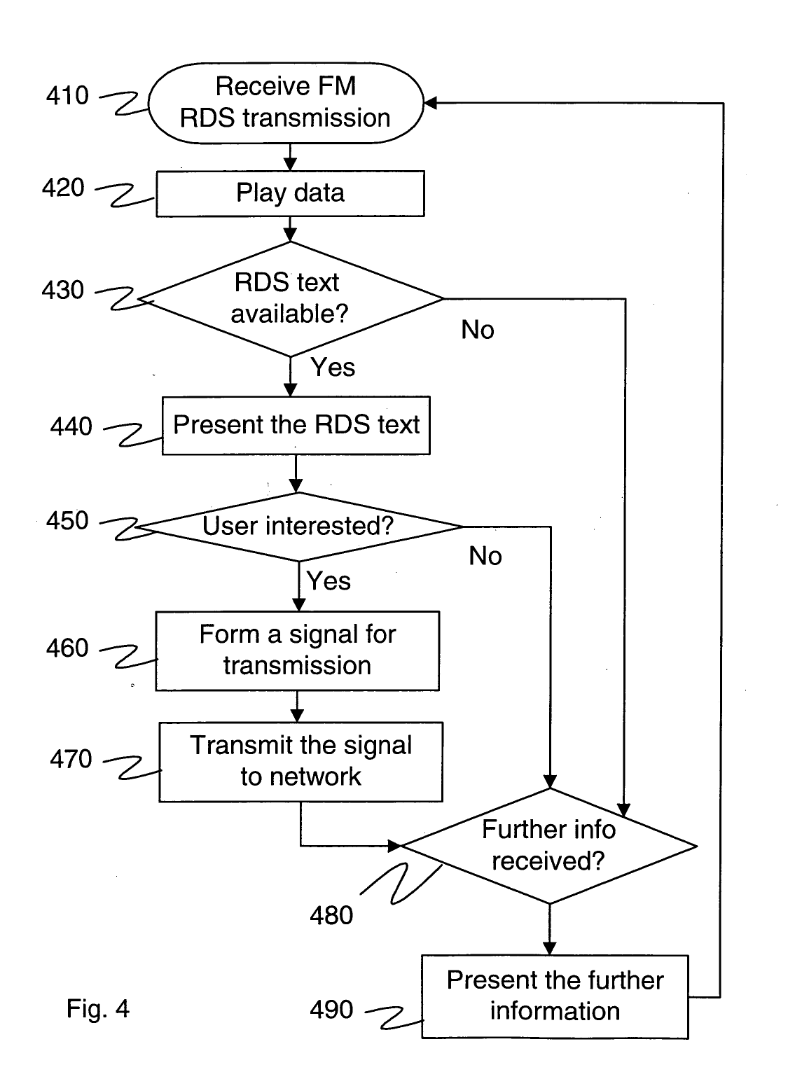

FIG. 4 shows a flow chart of the operation of the mobile radio device 111 of FIG. 1. The operation starts from block 410, in which the mobile radio device 111 receives an FM RDS transmission, or a short clip of a transmission.

In block 420, the mobile radio device 111 then presents the transmission through the speaker of the user interface 207.

In block 430, the mobile radio device 111 then checks if the transmission contains RDS text to be displayed to a user, for example, the name of a song being presented or the artist name. If no, the operation jumps to block 480, otherwise it continues to block 440.

In block 440, the mobile radio device 111 presents the RDS text. Typically, the RDS text changes temporally so that the text is rolled through the UI 207 display allowing the use of display not capable of presenting all the text at once. With modern mobile stations, the displays have high resolutions compared to early car radio displays. Thus the mobile radio device 111 preferably adds new texts on top of old ones and scrolls, if necessary, some older texts out of sight yet buffering it in the memory 204 so that the user can easily browse in the texts provided presently and earlier.

In block 450, the mobile radio device 111 detects if a user has indicated interest to the transmission by using the UI 207, for instance. If no, the operation jumps to block 480, otherwise it proceeds to block 460.

In block 460, the mobile radio device 111 forms an associated information signal to the GSM network, containing a pointer to the transmission that was received when the user's interest was indicated. This pointer may be an identifier specific to an item of entertainment content that was received such as the name of the item of entertainment content or at the simplest level the time (and optionally date) and program identifier (such as program name or channel). Using the pointer, the VASS 140 can identify the item of entertainment content. Advantageously, the user is allowed to browse the received associated information regarding the past items of entertainment content so that the pointer may relate to an earlier received item of entertainment content.

In block 470, the mobile radio device 111 transmits the associated information signal containing the pointer to the GSM network using the GSM module 205.

In block 480, the mobile radio device 111 checks if it has received using its GSM module 205 value-added information responsive to an associated information signal sent earlier to the GSM network. If no, the operation resumes to start, block 410, otherwise it continues to block 490.

In block 490, the mobile radio device 111 presents the value-added information. Preferably, this presentation includes a step of indicating the availability of the information using the user interface, typically by means of a visible or audible indication. In this case, the presentation of the information is carried out only after a user has accepted the presentation by the user interface 207.

The value-added information typically contains information on the item of entertainment content and/or playable data that can be presented to the user. The information on the item of entertainment content is typically information on the artist history, discography or a mobile shopping offer regarding a recording of the item of entertainment content. The playable data typically contains content which is likely to be interesting to a user. The content may be one or more clips of other production of the same artist, producer, label or same genre of music, movies, related computer games or news clips going further to an interesting news topic.

In a further enhanced embodiment, the mobile radio device 111 receives, instead of all the value-added information the VASS 140 has gathered, a taster that can be presented to the user together with a pricing information that indicates a price associated with all the information. In this case, the mobile radio device 111 is configured to input an authentication code, typically a PIN code, to verify the approval of the service. On receiving the code, the mobile radio device 111 may either check the code itself or send it preferably encrypted to the VASS 140 through the GSM telecommunications network for the VASS to check it. In either case, if the PIN checks out correctly, the VASS 140 will send all the value-added information and only then the mobile radio device 111 can present it in full. The invoicing for all the information is preferably arranged through the mobile telephone subscription invoicing so that no separate invoicing is needed and no new creditability checks are required.

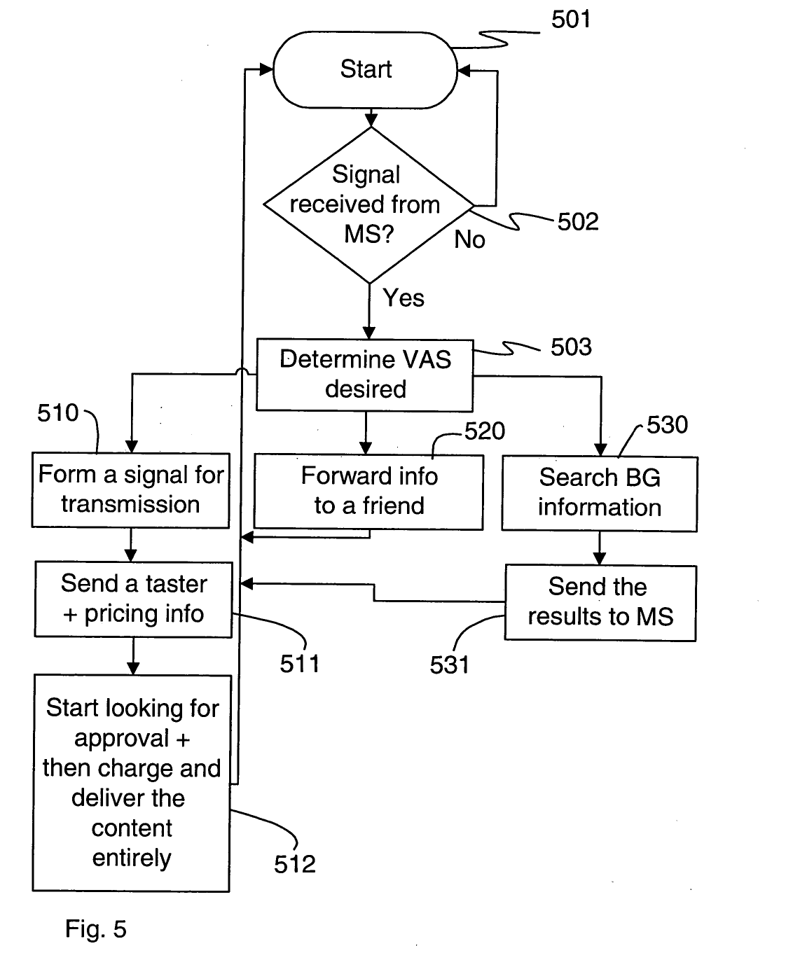

FIG. 5 shows a flow chart of the operation of the VASS 140 of FIG. 1. FIG. 5 shows not only the operation according to the preferred embodiment but also the operation in the further enhanced embodiment in which a taster can be provided and then the full content can be supplied against a payment. The flow chart starts from block 501, wherein the VASS may serve other mobile radio devices or perform any normal tasks. It should be appreciated that, as a server, the VASS 140 is capable of providing a number of substantially parallel processing threads, or multitask and the operation in FIG. 5 represents the serving of the mobile radio device 111 in one or more such processing threads.

In block 502 the VASS 140 checks if it has received from the mobile radio device 111 the associated information signal described in the foregoing. If not, the operation returns to start 501, otherwise it proceeds to block 503.

In block 503, the VASS 140 determines which particular desired Value-added Service (VAS) to provide. If it is providing related content, the operation branches to block 510. If it is forwarding information, or a pointer or bookmark related to an item of entertainment content, then the operation branches to block 520. If it is searching for background information such as discography, then the operation branches to block 530.

In block 510, the VASS 140 retrieves related content. If it fails, it resumes to block 501 and typically sends a descriptive error message to the mobile radio device 111.

In block 511, the VASS 140 sends pricing information indicating the fee of providing the related content. The VASS 140 may send a taster to support a user's decision on purchasing the related content in its entirety, if such a taster is available.

In block 512, the VASS 140 starts a new processing thread to look for a confirmation from the mobile radio device 111 and to charge and deliver the related content in its entirety on receiving the confirmation. The thread typically has a predetermined expiry time after which it is stopped in order not to overload the VASS 140. The procedure then returns to start in block 501.

In block 520, the VASS 140 forwards the information related to an item of entertainment content to another mobile radio device using an address included in the associated information signal or separately determined, for example by enquiring the sending mobile radio device 111. The procedure then returns to start in block 501.

In block 530, the VASS 140 searches for background information relating to the item of entertainment content identified in the associated information signal. This search can be based on the use of an Internet search engine in which the associated information signal or its part is fed in a search engine.

In block 531, the VASS 140 then sends the results, either information found or a mention of not finding any, to the mobile radio device 111. The procedure then returns to the start block 501.

In a further preferred embodiment, the mobile radio device 111 is configured to buffer in block 410 in the memory 204 the associated information relating to past items of entertainment content. The recent development in memory and multimedia coding technology enables a still further preferred embodiment wherein the mobile radio device 111 buffers the past items of entertainment content, or at least parts (samples) of them. In this embodiment, the change of items of entertainment content can be determined using media coding technology or by the change of the associated information, particularly if the associated information changes temporally synchronised with the broadcasting of the items of entertainment content. In block 450, the user is then provided with a list or an option to obtain a list of previous items of entertainment content, or alternatively samples of these items are presented to the user one by one until they all have been introduced or the user stops the presentation. The replay of the items of entertainment content, or their samples, can take place with a substantially low bandwidth so as to reduce storage requirement. It suffices that the user can recognise the items of entertainment content in order to allow subsequent selection of the associated information without the user having to remember the items listed.

In a yet further preferred embodiment, the mobile radio device 111 is configured to exchange the associated information signal or associated information with another electronic device locally using the local communications unit 208 and port 209. It may either send or receive the associated information signal or associated information. In case the mobile radio device 111 receives the associated information, it is able to form the associated information signal based on the associated information. With the associated information signal, it may request a service as described in the foregoing. Advantageous to this embodiment, the users may choose which subscription or network to use and shift costs or use the network that has the most suitable VAS available. The another electronic device may be a mobile or fixed device, such as a personal computer or a game station.

In one alternative embodiment, the mobile radio device 111 is configured so that it can present only the associated information without presenting the item of entertainment content. In case of RDS radio, the radio may be muted whilst associated RDS text is presented so that they can still be used to form the associated information signal.

The functionality for the mobile radio device 111 and the VASS 140 is typically provided in form of software code that determines their operation. The software may be provided by any means known from the art, for example on a media carrier such as a data tape, magnetic disc, optical disc, magneto-optical disc and non-volatile memory components. The software may also be provided by a data signal over a wireless or fixed connection either on initiation of an external party or by the radio device 111 or VASS 140 itself.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. For example, the telecommunications network may be a digital or analogue land mobile telecommunications network such as GSM, CDMA, IS-95, W-CDMA, PDC, NMT, AMPS, a satellite telecommunications network, a wireless LAN, or a fixed network such as a public switch telephone network or a wired LAN or Wide Area Network (WAN). The item of entertainment content may be a song, video, movie trailer, advertisement, news item, or an educational lecture or presentation, for instance. The broadcast station may be, for example, an FM station, an AM station, a Digital Audio Broadcast (DAB) station, a television station, terrestrial digital television station or satellite television station. The radio device may be, for example, a mobile communication device, a portable communication device, a mobile telephone, a Personal Digital Assistant device (PDA), a Personal Computer (PC), a portable computer or a game station.

1. A method in a radio device comprising the steps of:
receiving radio broadcast item of entertainment content and associated information for the item of entertainment content;
allowing a user to request a value-added service based on the associated information; and
responsive to the request, producing an associated information signal based on the associated information for providing the value-added service.

2. A method according to claim 1 further comprising receiving the broadcast item from an FM radio broadcast.

3. A method according to claim 1 further comprising buffering previous associated information so that a user may select the associated information related to a past item of entertainment content as the basis for forming the associated information signal.

4. A method according to claim 1 further comprising buffering at least portions of the past items of entertainment content and presenting them again so that a user can later decide if he or she wishes to obtain value-added services based on a particular item of entertainment content.

5. A method according to claim 1 further comprising including in the associated information signal sufficient information for identifying the item of entertainment content.

6. A method in a server accessible to a radio device, comprising the steps of:
receiving from a radio device an associated information signal based on radio broadcast associated information for a radio broadcast item of entertainment content;
preparing value-added information related to the item of entertainment content based on the associated information signal; and
outputting the value-added information.

7. A method according to claim 6 wherein the value-added information comprises information related to an item of entertainment content received earlier by the radio device.

8. A method according to claim 6, wherein the value-added information comprises a sample of related item of entertainment content such as song, movie or game.

9. A method according to claim 6, wherein the value-added information comprises background information related to the item of entertainment content.

10. A method according to claim 6, wherein the value-added information comprises a recommendation of a particular item of entertainment content received earlier by the radio device.

11. A radio device comprising:
a radio receiver for receiving a radio broadcast item of entertainment content and associated information for the item of entertainment content;
a user interface for allowing a user to request a value-added service based on the associated information; and
a processor for producing an associated information signal based on the associated information for providing the value-added service responsive to the request.

12. A radio device according to claim 11 selected from a group consisting of: a mobile station, a personal digital assistant device, a portable computer, a personal computer, a home entertainment device, a portable electronic game, a game station, a two-way paging device and a two-way car communication unit.

13. A radio device according to claim 11, wherein the receiver is adapted to receive broadcast items of entertainment content and associated information from an FM radio broadcast signal.

14. A radio device according to claim 11 further comprising a memory for buffering previous associated information and the user interface being configured to allow a user select the associated information related to a past item of entertainment content as the basis for forming the associated information signal to the telecommunications network.

15. A radio device according to claim 11 further comprising a memory for buffering samples of the past items of entertainment content and the user interface being configured to present them again so that a user can later decide if a value-added service based on a particular item of entertainment content is desired.

16. A radio device according to claim 11 further comprising a transmitter for transmitting the associated information signal.

17. A server accessible to a radio device, comprising:
an input for receiving from a radio device an associated information signal based on a radio broadcast item of entertainment content received by the radio device;
a processor for preparing value-added information based on the associated information signal; and
an output for outputting the value-added information.

18. A system comprising a server and a plurality of radio devices accessible to the server, a radio device comprising:
a radio receiver for receiving radio broadcast item of entertainment content and associated information for the item of entertainment content;
a user interface for allowing a user to request a value-added service based on the associated information;
a processor for producing an associated information signal based on the associated information for providing the value-added service responsive to the request; and
a transmitter for transmitting the associated information signal to the server; the server comprising:
an input for receiving the associated information signal from the radio device;
a processor for preparing value-added information based on the associated information signal; and
an output for outputting the value-added information.

19. A system according to claim 18, further comprising a radio broadcast station for radio broadcasting items of entertainment content and associated information for them.

20. A system according to claim 18, further comprising a first data storage containing program information using which together with the associated information signal the server can identify the item of entertainment content.

21. A system according to claim 18, further comprising a second data storage containing value-added information related to various items of entertainment content.

22. A computer program product for controlling a radio device, comprising:
computer executable program code for causing the radio device to receive radio broadcast item of entertainment content and associated information for the item of entertainment content;
computer executable program code for causing the radio device to allow a user to request a value-added service based on the associated information; and
computer executable program code for causing the radio device to produce, responsive to the request, an associated information signal based on the associated information for providing the value-added service.

23. A computer program product for controlling server accessible to a radio device, comprising:
computer executable program code for causing the server to receive from the radio device an associated information signal based on a radio broadcast item of entertainment content received by the radio device;
computer executable program code for causing the server to prepare value-added information based on the associated information signal; and
computer executable program code for causing the server to output the value-added information.

24. A method generating revenue by charging for the provision, on request, of value-added information related to a radio broadcast item of entertainment content received by a radio device.

25. A method of providing, on request, of value-added information related to a radio broadcast item of entertainment content received by the radio device.

26. (canceled)
